(19) United States
(12) Patent Application Publication
(10) Pub. No.: US 2022/0194079 A1
(43) Pub. Date: Jun. 23, 2022

(54) LIQUID DISCHARGE DEVICE AND IMAGE FORMING APPARATUS

(71) Applicants: Shunsuke Fujio, Kanagawa (JP); Toshihiro Tsukagoshi, Kanagawa (JP)

(72) Inventors: Shunsuke Fujio, Kanagawa (JP); Toshihiro Tsukagoshi, Kanagawa (JP)

(73) Assignee: Ricoh Company, Ltd., Tokyo (JP)

(21) Appl. No.: 17/644,877

(22) Filed: Dec. 17, 2021

(30) Foreign Application Priority Data
Dec. 21, 2020 (JP) 2020-211462
Nov. 18, 2021 (JP) 2021-188091

(51) Int. Cl. B41J 2/045

(52) U.S. Cl. CPC B41J 2/04588; B41J 2/04593; B41J 2/04586; B41J 2/04581

(57) ABSTRACT

A liquid discharge device includes a plurality of sets of a liquid chamber, a nozzle, a piezoelectric element, and an output waveform generator. The liquid chamber stores a liquid. The nozzle communicates with the liquid chamber. The piezoelectric element causes the liquid in the liquid chamber to be discharged from the nozzle as a droplet in response to application of a voltage to the piezoelectric element. The output waveform generator generates a drive waveform of the voltage applied to the piezoelectric element. The output waveform generator includes an output voltage selector to combine multiple voltages to generate the drive waveform and a slope switching selector to switch a slope of the drive waveform generated by the output voltage selector.

### CROSS-REFERENCE TO RELATED APPLICATIONS

This patent application is based on and claims priority pursuant to 35 U.S.C. § 119(a) to Japanese Patent Application Nos. 2020-211462, filed on Dec. 21, 2020 and 2021-188091, filed on Nov. 18, 2021, in the Japan Patent Office, the entire disclosure of each of which is hereby incorporated by reference herein.

### BACKGROUND

### Technical Field

Aspects of the present disclosure relate to a liquid discharge device and an image forming apparatus.

### Description of the Related Art

There is known an image forming apparatus including a conveyor that conveys a medium and an image forming unit that forms an image on the medium conveyed by the conveyor. The image forming unit uses, for example, an inkjet recording method in which ink is discharged from each of multiple nozzles at a predetermined timing to form the image on the medium.

### SUMMARY

Embodiments of the present disclosure describe an improved liquid discharge device that includes a plurality of sets of a liquid chamber, a nozzle, a piezoelectric element, and an output waveform generator. The liquid chamber stores a liquid. The nozzle communicates with the liquid chamber. The piezoelectric element causes the liquid in the liquid chamber to be discharged from the nozzle as a droplet in response to application of a voltage to the piezoelectric element. The output waveform generator generates a drive waveform of the voltage applied to the piezoelectric element. The output waveform generator includes an output voltage selector to combine multiple voltages to generate the drive waveform and a slope switching selector to switch a slope of the drive waveform generated by the output voltage selector.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating an overall configuration of an image forming apparatus according to an embodiment of the present disclosure;

FIGS. 2A and 2B are schematic views illustrating a structure of a head module of the image forming apparatus;

FIG. 3 is a block diagram of a control circuit of the image forming apparatus;

FIG. 4 is a block diagram illustrating a circuit configuration of an output waveform generator in the control circuit;

FIGS. 5A and 5B are a timing chart and a graph illustrating an example of a drive waveform that is generated by an output voltage selector of the output waveform generator and is not sloped;

FIGS. 6A and 6B are a timing chart and a graph illustrating an example of the drive waveform illustrated in FIGS. 5A and 5B that is sloped; and

FIGS. 7A and 7B are a timing chart and a graph illustrating another example of the drive waveform illustrated in FIGS. 5A and 5B that is sloped.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a,” “an,” and “the” are intended to include the plural forms as well, unless the context clearly indicates otherwise.

It is to be noted that the suffixes Y, M, C, and K attached to each reference numeral indicate only that components indicated thereby are used for forming yellow, magenta, cyan, and black images, respectively, and hereinafter may be omitted when color discrimination is not necessary.

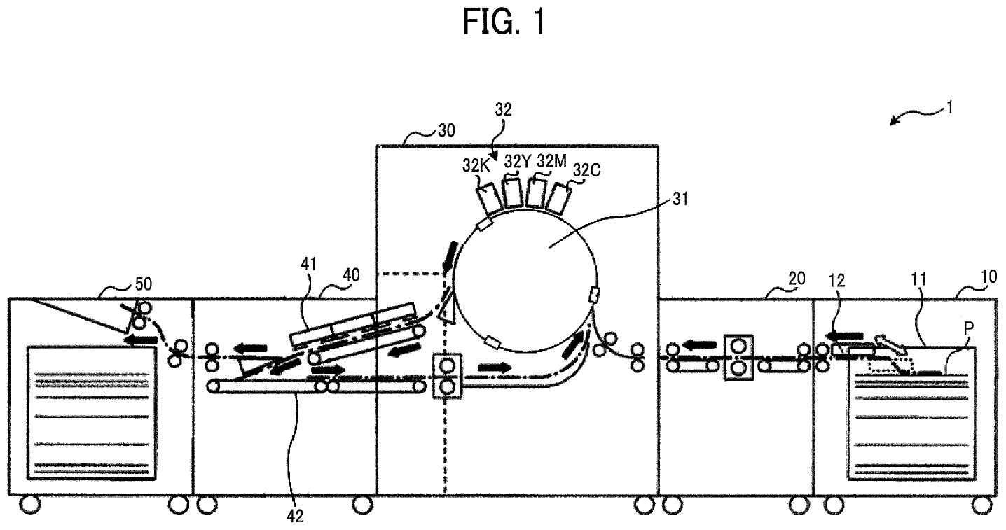

Hereinafter, with reference to the drawings, a description is given of an image forming apparatus 1 according to an embodiment of the present disclosure. FIG. 1 is a schematic view illustrating an overall configuration of the image forming apparatus 1 according to the present embodiment. The image forming apparatus 1 includes a sheet supply unit 10, a pretreatment unit 20, an image forming unit 30, a drying unit 40, and a sheet stacking unit 50.

The sheet supply unit 10 includes a sheet feeding stacker 11 on which sheets P before an image is formed are stacked, and an air separator 12 that picks up the sheets P stacked on the sheet feeding stacker 11 one by one and supplies the sheets P to the pretreatment unit 20. The sheet P refers to any medium, such as paper (paper sheet), an overhead projector (OHP) transparency, thread, fiber, fabric, leather, metal, plastic, glass, wood, or ceramic onto which ink can adhere to form an image.

The pretreatment unit 20 applies pretreatment liquid (treatment liquid) to one side or both sides of the sheet P supplied from the sheet supply unit 10, and supplies the sheet P coated with the pretreatment liquid to the image forming unit 30. The pretreatment liquid has a function of aggregating ink, and is applied to the sheet P before the image forming unit forms an image on the sheet P to improve image quality, for example, to prevent ink from bleeding on the sheet P or to assist ink in permeating the sheet P.

The image forming unit 30 employs an inkjet method in which ink is discharged onto the sheet P to form an image on the sheet P. The image forming unit 30 includes a cylindrical drum (conveyor) 31 that conveys the sheet P and a head module (liquid discharge device) 32 that discharges ink onto the sheet P. The cylindrical drum 31 holds the sheet P supplied from the pretreatment unit 20 on the surface (circumferential surface of the drum), conveys the sheet P to a position facing the head module 32, and supplies the sheet P on which the head module 32 has formed an image to the drying unit 40. The head module 32 includes a plurality of head modules 32C, 32M, 32Y, and 32K arranged radially along the surface of the cylindrical drum 31. The head modules 32C, 32M, 32Y, and 32K discharge inks of colors of cyan (C), magenta (M), yellow (Y), and black (K), respectively.

The drying unit 40 dries the sheet P on which an image has been formed by the image forming unit 30. The drying unit 40 includes a dryer 41 that blows hot air onto the sheet P and a sheet reverse mechanism 42 that reverses the sheet P and supplies the sheet P to the image forming unit 30 again. That is, when an image is formed on only one side of the sheet P, the drying unit 40 dries the sheet P supplied from the image forming unit 30 with the dryer 41 and supplies the sheet P to the sheet stacking unit 50. On the other hand, when images are formed on both sides of the sheet P, the drying unit 40 dries the sheet P supplied from the image forming unit 30 with the dryer 41, reverses the sheet P with the sheet reverse mechanism 42, and supplies the sheet P to the image forming unit 30. Thereafter, the drying unit 40 dries the sheet P, on both sides of which the image forming unit 30 has formed images, with the dryer 41 and supplies the sheet P to the sheet stacking unit 50.

That is, after the image forming unit 30 forms an image (images) on the sheet P, the sheet P is dried by the drying unit 40 and stacked in the sheet stacking unit 50. The sheet stacking unit 50 may perform so-called “post-processing” on the sheets P supplied from the drying unit 40, such as punching processing for punching holes, edge binding processing for binding edges of a bundle of sheets P, and saddle stitching processing for saddle stitching.

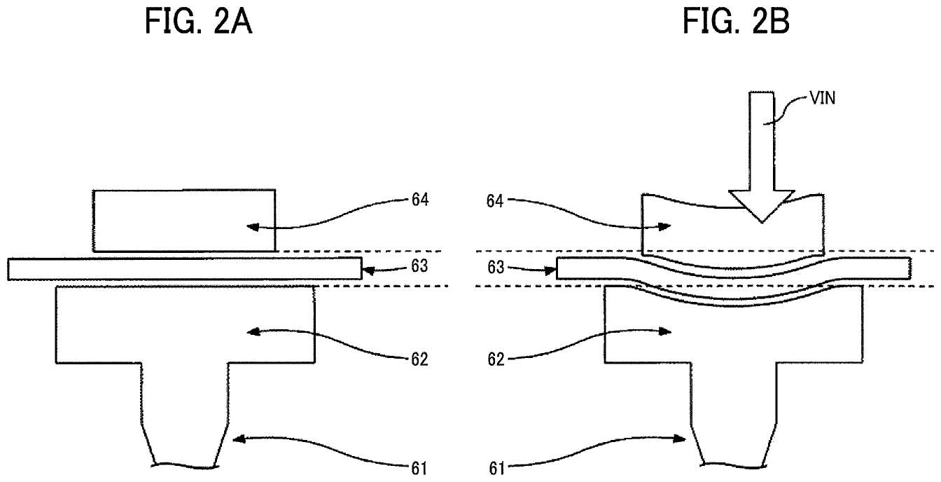

FIGS. 2A and 2B are schematic views illustrating a structure of the head modules 32C, 32M, 32Y, and 32K. Each of the head modules 32C, 32M, 32Y, and 32K includes a plurality of sets of a nozzle 61, an ink chamber (liquid chamber) 62, a diaphragm 63, a piezoelectric element 64, and an output waveform generator 120 described later. The multiple nozzles 61 are arranged on the lower surface of each of the head modules 32C, 32M, 32Y, and 32K. The ink chamber 62 temporarily stores ink (liquid) supplied from an ink cartridge and communicates with the corresponding nozzle 61.

As a voltage VIN is applied to the piezoelectric element 64, the piezoelectric element 64 vibrates the corresponding diaphragm 63. More specifically, when the voltage VIN is applied to the piezoelectric element 64 as illustrated in FIG. 2B, the volume of the ink chamber 62 decreases as compared to when no voltage is applied to the piezoelectric element 64 as illustrated in FIG. 2A. As a result, ink in the ink chamber 62 is pressurized and discharged from the nozzle 61 as an ink droplet (liquid droplet). That is, the piezoelectric element 64 causes the ink in the ink chamber 62 to be discharged from the nozzle 61 as a droplet in response to application of the voltage VIN to the piezoelectric element 64.

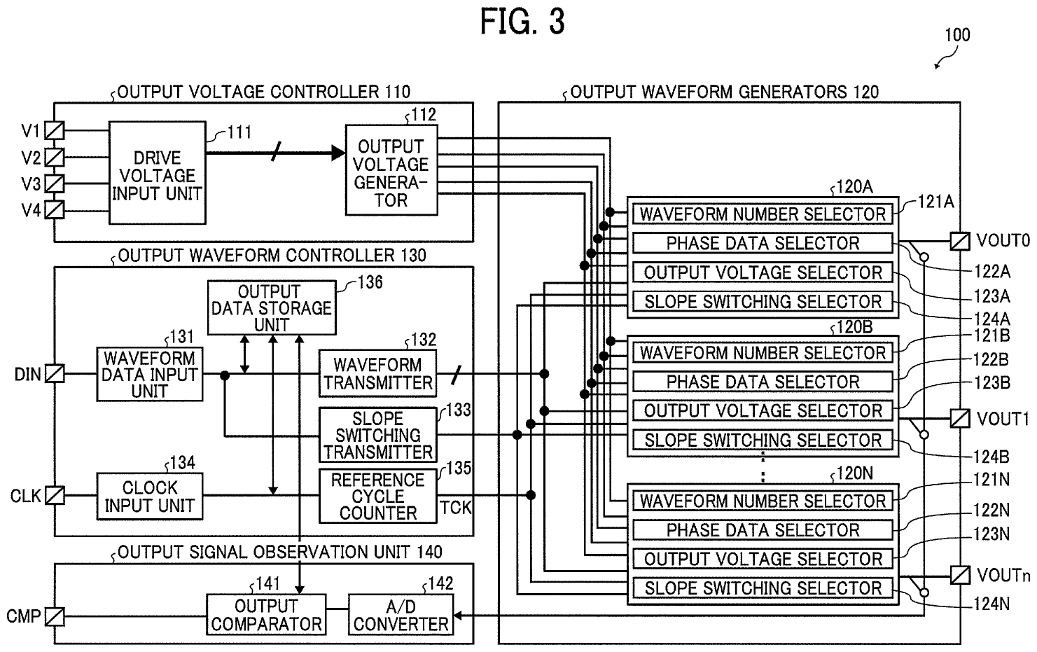

Each of the head modules 32C, 32M, 32Y, and 32K includes a control circuit 100 illustrated in FIG. 3. FIG. 3 is a block diagram of the control circuit 100. The control circuit 100 causes the piezoelectric elements 64 to vibrate, causing ink droplets to be discharged from each of the multiple nozzles 61 at a predetermined timing. More specifically, the control circuit 100 generates a drive waveform of a voltage to be applied to each of the multiple piezoelectric elements 64. The control circuit 100 is implemented by, for example, a driver integrated circuit (IC).

As illustrated in FIG. 3, the control circuit 100 includes, for example, an output voltage controller 110, multiple output waveform generators 120A, 120B, and to 120N, an output waveform controller 130, and an output signal observation unit 140. Hereinafter, the multiple output waveform generators 120A, 120B, and to 120N are also collectively referred to as “output waveform generators 120,” and one of the multiple output waveform generators 120A, 120B, and to 120N is referred to as an “output waveform generator 120” unless distinguished.

The output voltage controller 110 generates multiple fixed voltages from a direct current (DC) voltage supplied from an external power source, and supplies the generated multiple fixed voltages to each of the multiple output waveform generators 120A, 120B, and to 120N. The output voltage controller 110 includes, for example, a drive voltage input unit 111 and an output voltage generator 112.

The drive voltage input unit 111 is a circuit that inputs the multiple fixed voltages. As illustrated in FIG. 3, four fixed voltages V1, V2, V3, and V4 are input, for example. In the present embodiment, the fixed voltages V1, V2, V3, and V4 are 20 V, 10 V, 5 V, and 25 V, respectively. The number of fixed voltages is two or more, not limited to four illustrated in FIG. 3, and the values of the fixed voltages are not limited to the above-described example.

The output voltage generator 112 generates voltages to be supplied to the output waveform generators 120. Hereinafter, a description is given of an example in which the four fixed voltages V1, V2, V3, and V4 input from the drive voltage input unit 111 are supplied to the output waveform generators 120. Alternatively, the output voltage generator 112 may convert the fixed voltages V1, V2, V3, and V4 input from the drive voltage input unit 111 and supply the converted fixed voltages to the multiple output waveform generators 120A, 120B, and to 120N.

The multiple output waveform generators 120A, 120B, and to 120N correspond to the respective multiple nozzles 61 (in other words, the multiple piezoelectric elements 64). The output waveform generator 120 generates a drive waveform of a voltage to be applied to the corresponding piezoelectric element 64 based on the fixed voltages V1, V2, V3, and V4 supplied from the output voltage controller 110. The output waveform generator 120 includes, for example, a waveform number selector 121, a phase data selector 122, an output voltage selector 123, and a slope switching selector 124. Here, suffixes A, B, and N of the reference numerals of the above selectors are omitted because the output waveform generators 120A, 120B, and to 120N have the same configuration.

The waveform number selector 121 selects a waveform number indicating an output terminal that outputs the generated drive waveform. The phase data selector 122 selects phase data indicating an output timing of the generated drive waveform. The output voltage selector 123 combines the fixed voltages V1, V2, V3, and V4 supplied from the output voltage controller 110 to generate a drive waveform. The slope switching selector 124 switches a slope of the drive waveform generated by the output voltage selector 123. The “slope of the drive waveform” refers to, for example, a gradient of an increase and a decrease in voltage. The “switching the slope” refers to, for example, switching from a steep slope to a gentle slope or switching from a gentle slope to a steep slope.

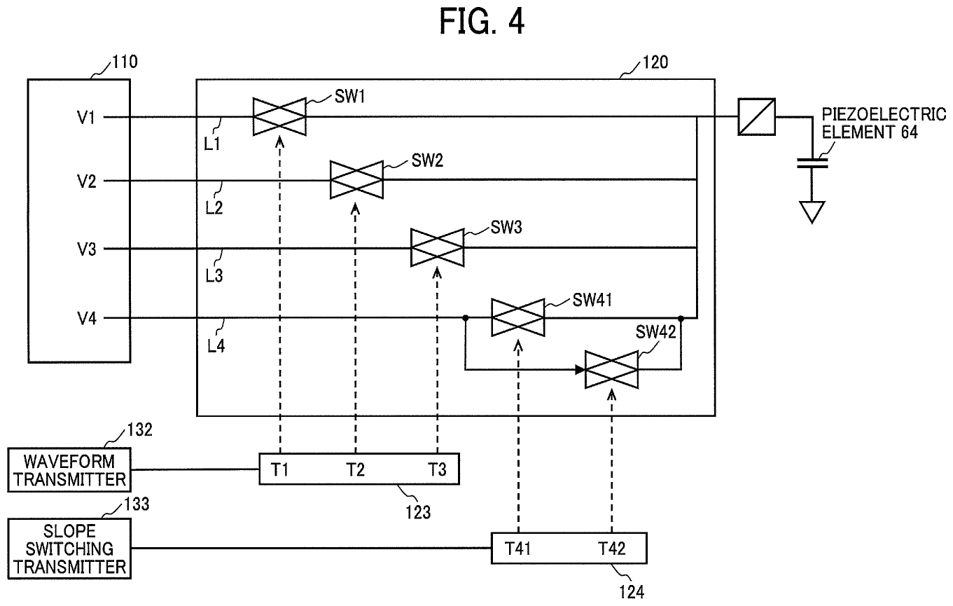

The configurations of the output voltage selector 123 and the slope switching selector 124 are described with reference to FIG. 4. FIG. 4 is a block diagram illustrating a circuit configuration of the output waveform generator 120.

As illustrated in FIG. 4, the output waveform generator 120 includes a multiple signal lines L1, L2, L3, and L4 to which the fixed voltages V1, V2, V3, and V4 are supplied from the output voltage controller 110, respectively. Switches (selection switches) SW1, SW2, and SW3 are disposed on the signal lines L1, L2, and L3, respectively. Further, switches (slope switches) SW41 and SW42 are disposed in parallel on the signal line L4. In the present embodiment, the fixed voltage V4 is an example of a specific voltage. The number of switches disposed on the signal line L4 is not limited to two, and may be three or more. The number of the specific voltages is not limited to one, and may be two or more.

The switches SW1, SW2, SW3, SW41, and SW42 switch between a conductive state in which the corresponding signal lines are conductive and a cutoff state in which the corresponding signal lines are cut off. The output voltage selector 123 switches the states of the switches SW1, SW2, and SW3 in response to combination signals T1, T2, and T3 transmitted from a waveform transmitter 132 described later. The slope switching selector 124 switches the states of the switches SW41 and SW42 in response to slope pattern signals T41 and T42 transmitted from a slope switching transmitter 133 described later. Each of the switches SW41 and SW42 is, for example, a semiconductor switch that is arranged in series with an electric element, such as a resistance element. The states of the switches SW41 and SW42 are switched so as to change the resistance value of the switches SW41 and SW42 to switch the slope of the drive waveform.

The output waveform generator 120 combines fixed voltages supplied through the switches SW1, SW2, SW3, SW41, and SW42 in the conductive state among the fixed voltages V1, V2, V3, and V4 supplied to the multiple signal lines L1, L2, L3, and L4 to generate a drive waveform, and applies the generated drive waveform to the corresponding piezoelectric element 64.

With reference again to FIG. 3, the output waveform controller 130 transmits data (for example, combination signals, slope pattern signals, and reference signals, which are described later) for generating a drive waveform to each of the multiple output waveform generators 120A, 120B, and to 120N. The output waveform controller 130 includes, for example, a waveform data input unit 131, the waveform transmitter 132, the slope switching transmitter 133, a clock input unit 134, a reference cycle counter 135, and an output data storage unit (memory) 136.

The waveform data input unit 131 receives image data DIN from a main control unit of the image forming apparatus 1. The waveform data input unit 131 determines a discharge timing and an amount of liquid droplets to be discharged from each of the multiple nozzles 61 based on the received image data DIN.

The waveform transmitter 132 transmits data (combination signals) for determining a drive waveform to each of the multiple output waveform generators 120A, 120B, and to 120N. The combination signal indicates a combination of the conductive states and the cutoff states of the switches SW1, SW2, and SW3. More specifically, the combination signal includes the signal T1 indicating a timing for switching the state of the switch SW1, the signal T2 indicating a timing for switching the state of the switch SW2, and the signal T3 indicating a timing for switching the state of the switch SW3 in one cycle indicated by a reference signal TCK described later.

The output data storage unit 136 stores the multiple combination signals corresponding to liquid droplets to be discharged from the nozzles 61 in advance. The waveform transmitter 132 reads the combination signals corresponding to liquid droplets to be discharged from the nozzles 61 at the next timing from the output data storage unit 136 and transmits the combination signals to the respective output voltage selectors 123A, and 123B to 123N. The waveform data input unit 131 determines which combination signal is transmitted to which output voltage selector 123, for example.

The slope switching transmitter 133 transmits data (slope pattern signals) for determining a slope of a drive waveform to each of the multiple output waveform generators 120A, 120B, and to 120N. The slope pattern signal indicates a combination of the conductive states and the cutoff states of the switches SW41 and SW42. More specifically, the slope pattern signal includes the signal T41 indicating a timing for switching the state of the switch SW41 and the signal T42 indicating a timing for switching the state of the switch SW42 in one cycle indicated by the reference signal TCK.

The output data storage unit 136 stores the multiple slope pattern signals corresponding to the slope patterns of the drive waveforms in advance. The slope switching transmitter 133 reads slope pattern signals corresponding to the slope patterns of the drive waveforms applied to the piezoelectric elements 64 at the next timing from the output data storage unit 136 and transmits the slope pattern signals to the respective slope switching selectors 124A, 124B, and to 124N. The waveform data input unit 131 determines which slope pattern signal is transmitted to which slope switching selector 124, for example.

The clock input unit 134 receives a clock signal CLK from the main control unit of the image forming apparatus 1. Each circuit included in the control circuit 100 operates based on the clock signal CLK. The reference cycle counter 135 counts the clock signals CLK to generate reference signals TCK, and transmits the generated reference signals TCK to the respective output waveform generator 120A, 120B, and to 120N.

Hereinafter, a description is given of an example of one cycle in which the nozzles 61 discharge liquid droplets based on the reference signal TCK. Note that, in the present specification, the one cycle is also referred to as an “ink discharge cycle.” That is, one drive waveform is applied to the piezoelectric element 64 for each cycle, and the nozzle 61 periodically discharges liquid droplets based on the applied drive waveform. The ink discharge cycle according to the present embodiment may be an equal interval or may be time shared.

As described above, the output data storage unit 136 stores the multiple combination signals and the multiple slope pattern signals. The output data storage unit 136 includes, for example, a random access memory (RAM), a read only memory (ROM), or an electrically erasable programmable read-only memory (EEPROM).

The output signal observation unit 140 includes, for example, an output comparator 141 and an analog-to-digital (A/D) converter 142. The A/D converter 142 converts the output signals VOUT1, VOUT2, and to VOUTN into digital values. The output comparator 141 compares the digital values with expected values. The output comparator 141 outputs the comparison result, for example, a comparison determination signal CMP.

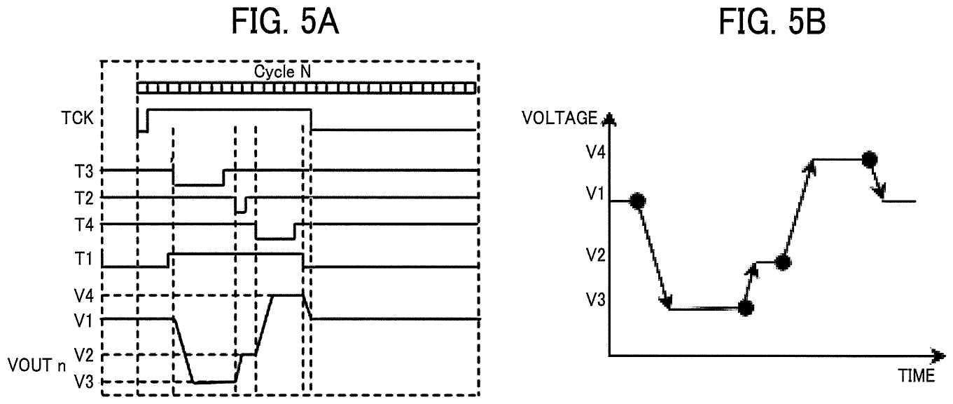

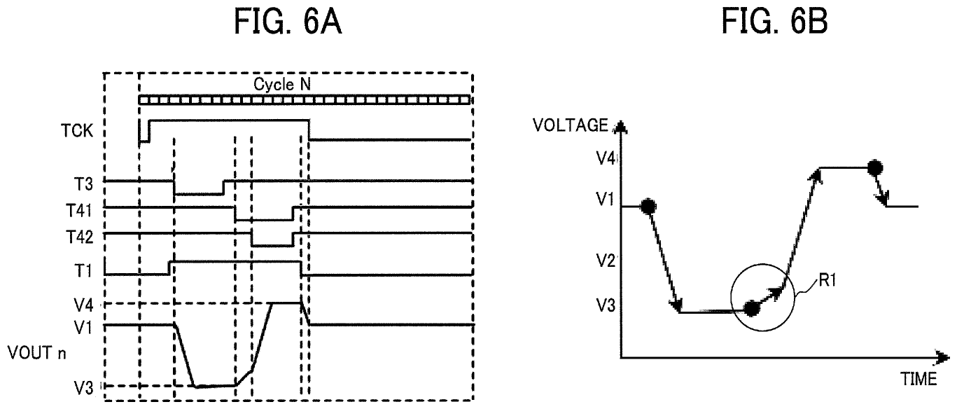

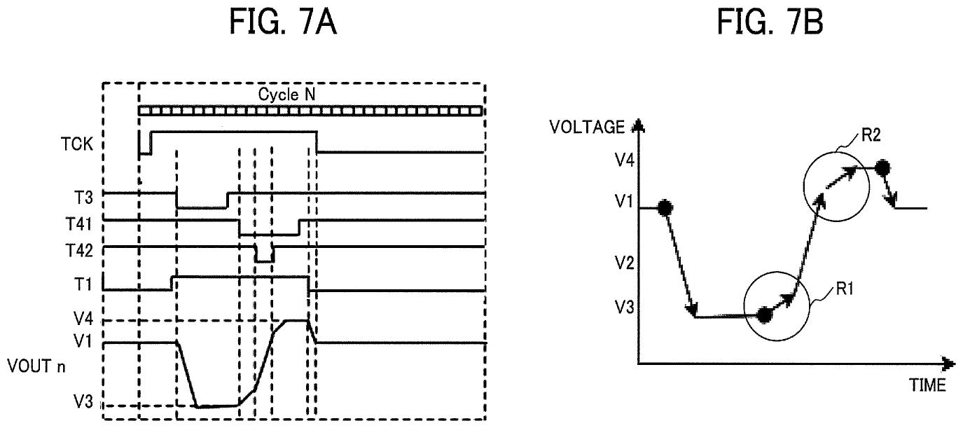

The circuit configuration of the control circuit 100 is not limited to the configuration illustrated in FIG. 3. That is, a specific circuit configuration is not limited to the above-described example as long as the circuit configuration can switch the slope pattern of the drive waveform as described below. FIGS. 5A and 5B are a timing chart and a graph illustrating an example of the drive waveform that is generated by the output voltage selector 123 and is not sloped. FIGS. 6A and 6B are a timing chart and a graph illustrating an example of the drive waveform that is illustrated in FIGS. 5A and 5B and is sloped. FIGS. 7A and 7B are a timing chart and a graph illustrating another example of the drive waveform that is illustrated in FIGS. 5A and 5B and is sloped.

In each of the signals T1, T2, T3, T4, T41, and T42 illustrated in FIGS. 5A, 6A, and 7A, the corresponding switch is in the conductive state when the signal is in the Low state, and the corresponding switch is in the cutoff state when the signal is in the High state. The signal T4 illustrated in FIG. 5A indicate a timing for switching the states of both the switches SW41 and SW42. That is, in the example illustrated in FIGS. 5A and 5B, the states of the switches SW41 and SW42 are switched at the same timing. In other words, FIGS. 5A and 5B illustrates a comparative example of the drive waveform that the output waveform generator 120 generates without the switch SW42. In examples illustrated in FIGS. 6A and 7A, since the switch SW2 is constantly in the cutoff state, the signal T2 is omitted in the drawings.

FIGS. 5A and 5B illustrate a drive waveform when only the switch SW1 is firstly in the conductive state, then only the switch SW3 is in the conductive state, then only the switch SW2 is in the conductive state, then only the switches SW41 and SW42 are in the conductive state, and finally only the switch SW1 is in the conductive state. As a result, the drive waveform illustrated in FIGS. 5A and 5B starts from the voltage V1, then drops to the voltage V3, then rises to the voltage V2, then rises to the voltage V4, and finally drops to the voltage V1.

FIGS. 6A and 6B illustrate a drive waveform when only the switch SW1 is firstly in the conductive state, then only the switch SW3 is in the conductive state, then only the switch SW41 is in the conductive state, then only the switches SW41 and SW42 are in the conductive state, and finally only the switch SW1 is in the conductive state. The drive waveform in FIG. 6B has a gentle slope in a circle R1 where the drive waveform starts rising from the voltage V3 to the voltage V4 (i.e., a first portion of the slope) as compared with the slope in the corresponding portion in FIG. 5B.

FIGS. 7A and 7B illustrate a drive waveform when only the switch SW1 is firstly in the conductive state, then only the switch SW3 is in the conductive state, then only the switch SW41 is in the conductive state, then only the switches SW41 and SW42 are in the conductive state, then only the switch SW41 is in the conductive state, and finally only the switch SW1 is in the conductive state. The drive waveform in FIG. 7B has gentle slopes in the circle R1 and a circle R2 where the drive waveform starts rising and finishes rising from the voltage V3 to the voltage V4 (i.e., the first portion and an end portion of the slope) as compared with the slopes in the corresponding portions in FIG. 5B.

Note that portions surrounded by the circles R1 and R2 in FIGS. 6B and 7B correspond to timings at which the switch SW41 is in the conductive state and the switch SW42 is in the cutoff state in FIGS. 6A and 7A. That is, the output waveform generator 120 according to the present embodiment sets one of the switches SW41 and SW42 to the conductive state and the other one to the cutoff state, thereby reducing the slope of the voltage rise smaller than the slope when both of the switches SW41 and SW42 are set to the conductive state.

According to the above-described embodiment, the following operational effects, for example, are achieved.

According to the above-described embodiment, since the output voltage selector 123 and the slope switching selector 124 are provided corresponding to each of the multiple nozzles 61 (in other words, the multiple piezoelectric elements 64), the slope of the drive waveform can be switched for each piezoelectric element 64. As a result, individual differences among the nozzles 61 can be absorbed, and ink droplets discharged from the multiple nozzles 61 can be leveled.

As an example, as illustrated in FIG. 6B, the first portion of the slope where the drive waveform starts rising from the voltage V3 to the voltage V4 is gentle, thereby suppressing ink discharge bending. The “ink discharge bending” is a phenomenon in which the movement of a part of the diaphragm 63 is delayed when a voltage is rapidly applied to the piezoelectric element 64, thereby bending the discharge direction of ink and obliquely discharging the ink from the nozzle 61.

As another example, as illustrated in FIG. 7B, the first portion and the end portion of the slope where the drive waveform starts rising and finishes rising from the voltage V3 to the voltage V4 is gentle, thereby suppressing mist generation in addition to the ink discharge bending. The “mist generation” is a phenomenon in which a force is applied to the diaphragm 63 at once when a voltage is rapidly applied to the piezoelectric element 64, thereby discharging a rough ink droplet. Here, the rough ink droplet is not a single ink droplet and includes both an ink droplet and particles of ink.

According to the above-described embodiment, the slope pattern signal to be transmitted to each of the multiple output waveform generators 120A, 120B, and to 120N is selected among the multiple slope pattern signals stored in advance in the output data storage unit 136, thereby improving the processing speed as compared to when the slope pattern signal is generated each time.

Liquid to be discharged from the nozzles 61 of the head module 32 is not limited to a particular liquid as long as the liquid has a viscosity or surface tension to be discharged from the head module 32. However, preferably, the viscosity of the liquid is not greater than 30 mPa·s under ordinary temperature and ordinary pressure or by heating or cooling. Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. These liquids can be used for, e.g., inkjet ink, surface treatment solution, a liquid for forming components of electronic element or light-emitting element or a resist pattern of electronic circuit, or a material solution for three-dimensional fabrication.

In the above-described embodiment, the control circuit 100 of the image forming unit has the configuration illustrated in FIG. 3. In addition, the present disclosure can also be applied to other apparatuses such as the pretreatment unit 20 that applies the pretreatment liquid to the sheet P and the like.

According to the present disclosure, the liquid discharge device can generate a drive waveform that individually matches each of the nozzles.

Embodiments of the present disclosure are not limited to the above-described embodiments, and various modifications can be made without departing from the technical scope of the present disclosure. It is therefore to be understood that the disclosure of the present specification may be practiced otherwise by those skilled in the art than as specifically described herein. Such embodiments and variations thereof are included in the scope and gist of the embodiments of the present disclosure and are included in the embodiments described in claims and the equivalent scope thereof.

What is claimed is:

1. A liquid discharge device comprising:
a plurality of sets of:
a liquid chamber configured to store a liquid;
a nozzle communicating with the liquid chamber;
a piezoelectric element configured to cause the liquid in the liquid chamber to be discharged from the nozzle as a droplet in response to application of a voltage to the piezoelectric element; and
an output waveform generator configured to generate a drive waveform of the voltage applied to the piezoelectric element, the output waveform generator including:
an output voltage selector configured to combine multiple voltages to generate the drive waveform; and
a slope switching selector configured to switch a slope of the drive waveform generated by the output voltage selector.

2. The liquid discharge device according to claim 1,
wherein the output waveform generator further includes:
a signal line to which a specific voltage that is one of the multiple voltages is supplied; and
multiple slope switches on the signal line in parallel,
wherein the slope switching selector is configured to switch each of the multiple slope switches between a conductive state in which the signal line is conductive and a cutoff state in which the signal line is cut off, to switch the slope of the drive waveform.

3. The liquid discharge device according to claim 2, further comprising:
a memory that stores multiple slope pattern signals each indicating a combination of the conductive state and the cutoff state of the multiple slope switches; and
a slope switching transmitter configured to transmit one of the multiple slope pattern signals stored in the memory to each of the slope switching selectors.

4. The liquid discharge device according to claim 2,
wherein the output waveform generator further includes:
multiple signal lines to each of which another one of the multiple voltages other than the specific voltage is supplied; and
multiple selection switches on the multiple signal lines, respectively,
wherein the output voltage selector is configured to switch each of the multiple selection switches between the conductive state and the cutoff state to generate the drive waveform.

5. The liquid discharge device according to claim 4, further comprising:
a memory that stores combination signals each indicating a combination of the conductive state and the cutoff state of the multiple selection switches; and
a waveform transmitter configured to transmit one of the combination signals stored in the memory to each of the output voltage selectors.

6. The liquid discharge device according to claim 1, further comprising an output voltage controller configured to generate the multiple voltages from a direct current voltage supplied from an external power source and supply the multiple voltages to each of the output waveform generators.

7. The liquid discharge device according to claim 1, further comprising a reference cycle counter configured to transmit a reference signal indicating a cycle in which the nozzle discharges the droplet of the liquid, to each of the output waveform generators,
wherein the output waveform generator is configured to generate the drive waveform for each cycle indicated by the reference signal and applies the drive waveform to the piezoelectric element.

8. An image forming apparatus comprising:
a conveyor configured to convey a medium; and
the liquid discharge device according to claim 1, configured to discharge ink that is the liquid toward the medium conveyed by the conveyor to form an image on the medium.
